(19) United States
(12) Patent Application Publication
(10) Pub. No.: US 2021/0080866 A1
(43) Pub. Date: Mar. 18, 2021

(54) IMAGE FORMING APPARATUS AND IMAGE FORMING METHOD

(71) Applicant: TOSHIBA TEC KABUSHIKI KAISHA, Tokyo (JP)

(72) Inventor: Kohei SUGIHARA, Izunokuni Shizuoka (JP)

(73) Assignee: TOSHIBA TEC KABUSHIKI KAISHA, Tokyo (JP)

(21) Appl. No.: 16/574,709

(22) Filed: Sep. 18, 2019

(51) Int. Cl. G03G 15/08

(52) U.S. Cl. CPC G03G 15/0877; G03G 15/0889

(57) ABSTRACT

An image forming apparatus includes an electrostatic latent image carrier; a charger to charge a surface of the image carrier; an exposure device to expose the surface of the image carrier charged by the charger based on image data to form an image thereon; a developing container configured to store developer; at least one stirring member to stir developer; a developer carrier to supply the stirred developer to the image carrier. The apparatus also includes a processor calculates a printing rate based on the image data and increases a stirring rotation speed if it is detected that the printing rate is reduced to be equal to or lower than a predetermined printing rate; and a drive variable control section.

### FIELD

Embodiments described herein relate generally to an image forming apparatus and an image forming method.

### BACKGROUND

An image forming apparatus that performs two-component development using a two-component developer composed of a toner and a carrier stores the developer in a developing device and performs development with the toner. In the image forming apparatus, the toner is replenished from a toner cartridge to the developing device if a toner density in the developing device decreases with consumption of the toner. On the other hand, even if the toner is replenished, if the carrier is not replenished, a performance of the carrier is degraded, which causes deterioration in a charge performance of the toner. A so-called trickle development system is provided to suppress the deterioration in the charge performance of the toner. In the trickle development system, the carrier is replenished simultaneously with replenishment of the toner and the excess developer is discharged simultaneously with the replenishment to stabilize a charge level of the developer.

The excess developer in a developing tank due to the replenishment of the toner and the carrier overflowing from a developer discharge opening for developer overflow provided at a predetermined position on a wall surface of the developing tank is discharged, and then is collected in a developer collection container. By sequentially repeating the replenishment and discharge described above, the deteriorated developer in the developing tank is replaced with newly supplied toner and carrier. In this way, an amount of developer in the developing tank is kept constant, the charge performance of the developer is maintained, and the deterioration in copy image quality is suppressed.

In recent years, a particle size of the toner tends to be reduced to improve a quality of an output image. Since consumption of the toner having a small particle size is reduced, an amount of the developer retained in the developing device for a long time increases. If the developer deteriorates due to retention for along time, there are problems such as a white streak due to soft caking, conveyance failure due to sticking, cleaning failure due to peeling and embedding of an external additive, and the like.

Thus, an image forming apparatus and an image forming method for preventing deterioration in the developer even in a case in which the toner having a small particle size is used are desired.

### DESCRIPTION OF THE DRAWINGS

FIG. 1 is a diagram illustrating a configuration of an image forming apparatus according to at least one embodiment;

FIG. 2 is a diagram illustrating a configuration of a processing unit of the image forming apparatus according to at least one embodiment;

FIG. 3 is a plan view illustrating a toner storing container incorporated in a developing device according to at least one embodiment;

FIG. 4 is a cross-section view illustrating the toner storing container incorporated in the developing device according to at least one embodiment; and

FIG. 5 is a diagram illustrating a rotation speed adjustment table according to at least one embodiment.

### DETAILED DESCRIPTION

In accordance with at least one embodiment, an image forming apparatus includes an electrostatic latent image carrier; a charging device configured to charge a surface of the electrostatic latent image carrier; an exposure device configured to expose the surface of the electrostatic latent image carrier, which is charged by the charging device based on image data, to form an electrostatic latent image; a developing container configured to store developer composed of a toner and a carrier; one or more stirring members configured to stir the developer in the developing container; a developer carrier configured to supply the stirred developer to the electrostatic latent image carrier; and a controller configured to calculate a printing rate based on the image data and increase a rotation speed of the one or more stirring members in response to a determination that the printing rate is equal to or lower than a predetermined printing rate.

Hereinafter, at least one embodiment is described with reference to the accompanying drawings.

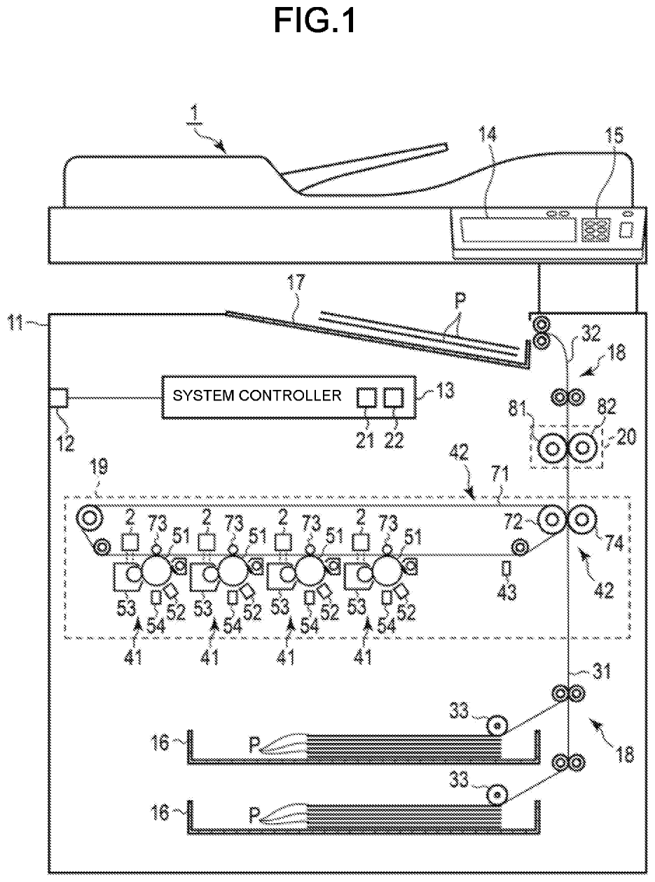

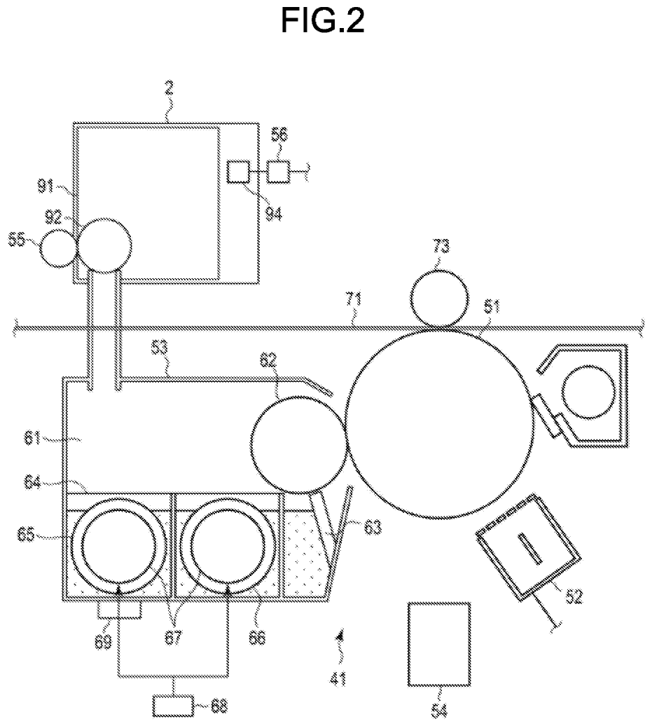

FIG. 1 is a diagram illustrating a configuration of an image forming apparatus 1 according to at least one embodiment. FIG. 2 is a diagram illustrating a part of the configuration of the image forming apparatus 1.

In at least one embodiment, an MFP (Multi-Function Peripheral) is described as an example of the image forming apparatus. The MFP has a plurality of functions such as a function of forming or printing a desired image on a print medium which is a paper or a sheet-like paper such as a resin sheet, a function of reading an image formed on the print medium as image information including electronic data, and the like. The MFP may further have a function of a facsimile machine.

For example, the image forming apparatus 1 includes a component for forming an image on the print medium with toner replenished from a toner cartridge 2. The image forming apparatus 1 of the present embodiment uses a toner of a small particle size (50% volume average particle size of about 4 to about 6 micrometers (μm)) and a magnetic carrier. The toner is, for example, a cyan (C) toner, a magenta (M) toner, a yellow (Y) toner and a black (K) toner.

As shown in FIG. 1, the image forming apparatus 1 includes a housing 11, a communication interface 12, a system controller 13, a display section 14, an operation interface 15, a plurality of sheet trays 16, a sheet discharge tray 17, a conveyance section (conveyor) 18, an image forming section 19 and a fixing device 20.

The housing 11 is a main body of the image forming apparatus 1. The housing 11 stores the communication interface 12, the system controller 13, the display section 14, the operation interface 15, the plurality of sheet trays 16, the sheet discharge tray 17, the conveyance section 18, the image forming section 19 and the fixing device 20.

The communication interface 12 establishes communication with other devices. The communication interface 12 is used, for example, for communication with a host device (external device). The communication interface 12 is, for example, an LAN (Local Area Network) connector or the like.

The system controller 13 controls the image forming apparatus 1. The system controller 13 includes, for example, a processor 21 and a memory 22. The system controller 13 is connected to the conveyance section 18, the image forming section 19 and the fixing device 20 via a bus or the like.

The processor 21 is an arithmetic element that executes an arithmetic processing. The processor 21 is, for example, a CPU (Central Processing Unit). The processor 21 performs various processing based on data such as programs stored in the memory 22. The processor 21 functions as a control section capable of executing various operations by executing the programs stored in the memory 22. The processor 21 controls rotation speeds of stirring members 65 and 66 described below. The control is a drive variable control for increasing the rotation speeds of the stirring members 65 and 66 if it is detected that a printing rate G is reduced to be equal to or lower than a predetermined printing rate.

The memory 22 stores programs and data used in the programs. The memory 22 also functions as a working memory. Specifically, the memory 22 temporarily stores data being processed by the processor 21, a program to be executed by the processor 21, and the like.

The processor 21 controls the conveyance section 18, the image forming section 19 and the fixing device 20 by executing the programs stored in the memory 22. The processor 21 executes the program stored in the memory 22 to perform a processing of generating a print job for forming an image on a print medium P. For example, the processor 21 generates the print job based on, for example, an image acquired from an external device via the communication interface 12. The processor 21 stores the generated print job in the memory 22.

The print job contains image data indicating an image to be formed on the print medium P. The image data may be data for forming an image on one print medium P, or data for forming an image on a plurality of print media P. Furthermore, the print job contains information indicating whether color printing or monochrome printing is performed.

The display section 14 is provided with a display that displays a screen according to a video signal input from the system controller 13 or a display control section such as a graphic controller (not shown). For example, screens for various settings relating to the image forming apparatus 1 are displayed on the display of the display section 14.

The operation interface 15 is connected to an operating member (not shown). The operation interface 15 transmits an operation signal corresponding to the operation of the operating member to the system controller 13. The operating member is, for example, a touch sensor, a keyboard or the like.

The plurality of sheet trays 16 accommodates the print media P, respectively. The print medium P can be placed in the sheet tray 16 from the outside of the housing 11. For example, the sheet tray 16 can be pulled out from the housing 11.

The sheet discharge tray 17 supports the print medium P discharged from the image forming apparatus 1.

The conveyance section 18 conveys the print medium P in the image forming apparatus 1. As shown in FIG. 1, the conveyance section 18 includes a plurality of conveyance paths. For example, the conveyance section 18 includes a sheet feed conveyance path 31 and a sheet discharge conveyance path 32.

The sheet feed conveyance path 31 and the sheet discharge conveyance path 32 each are configured by a plurality of motors, a plurality of rollers and a plurality of guides. Each of the plurality of motors rotates a shaft under control of the system controller 13 to rotate a roller in linkage with rotation of the shaft. The plurality of rollers rotates to move the print medium P. The plurality of guides controls a conveyance direction of the print medium P.

The print medium P is picked up from the sheet tray 16 and the print medium P picked up is fed to the image forming section 19 through the sheet feed conveyance path 31. The sheet feed conveyance path 31 is provided with pickup rollers 33 corresponding to the respective sheet trays. Each pickup roller 33 picks up the print medium P in the corresponding sheet tray 16 to convey it to the sheet feed conveyance path 31.

The sheet discharge conveyance path 32 is used to discharge the print medium P on which an image is formed from the housing 11. The print medium P discharged through the sheet discharge conveyance path 32 is supported by the sheet discharge tray 17.

Next, the image forming section 19 is described.

The image forming section 19 is the component for forming an image on the print medium P under the control of the system controller 13. Specifically, the image forming section 19 forms an image on the print medium P based on the print job generated by the processor 21. The image forming section 19 includes a plurality of processing units (processors) 41, a transfer mechanism 42 and a density sensor 43.

First, a configuration relating to image formation of the image forming section 19 is described.

The plurality of processing units 41 respectively corresponds to the cyan toner, the magenta toner, the yellow toner and the black toner, which are toner having small particle sizes. The toner cartridge 2 storing toner of a different color is connected to each processing unit 41. Since the plurality of processing units 41 has the same configuration except for the developer to be filled, one processing unit 41 is described.

FIG. 2 is a diagram illustrating a configuration of the processing unit 41. The processing unit 41 includes a photoconductive drum 51, an electrostatic charger 52 and a developing device (developer) 53. The image forming section 19 includes a plurality of exposure devices (exposers) 54, a plurality of toner replenishment motors 55 and a plurality of communication interfaces 56. An exposure device 54, a toner replenishment motor 55 and a communication interface 56 may be provided for each processing unit 41.

The photoconductive drum 51 is a photoconductor (electrostatic latent image carrier) provided with a cylindrical drum and a photoconductive layer formed on an outer circumferential surface of the drum. The photoconductive drum 51 rotates at a constant speed by a drive mechanism (not shown).

The electrostatic charger 52 uniformly charges a surface of the photoconductive drum 51. For example, the electrostatic charger 52 charges the photoconductive drum 51 to a uniform potential by applying a voltage (developing bias voltage) to the photoconductive drum 51 with a charging roller. The charging roller rotates as the photoconductive drum 51 rotates in a state in which a predetermined pressure is applied to the photoconductive drum 51.

The developing device 53 attaches the toner to the photoconductive drum 51. The developing device 53 includes a housing 61, a developing roller (developer carrier) 62, a doctor blade 63, a developer container (tank) 64, the stirring members (stirrers) 65 and 66, a gear 67, a motor 68 for driving the gear, a toner sensor 69 and the like.

The developer container 64 is a rectangular parallelepiped container for storing the developer composed of the toner and the carrier. The toner is replenished from the toner cartridge 2. The developing roller 62 rotates in the developer container 64 to absorb the developer on the surface thereof. The doctor blade 63 is arranged at a predetermined distance from the developing roller 62. The doctor blade 63 adjusts a thickness of the developer carried by the developing roller 62.

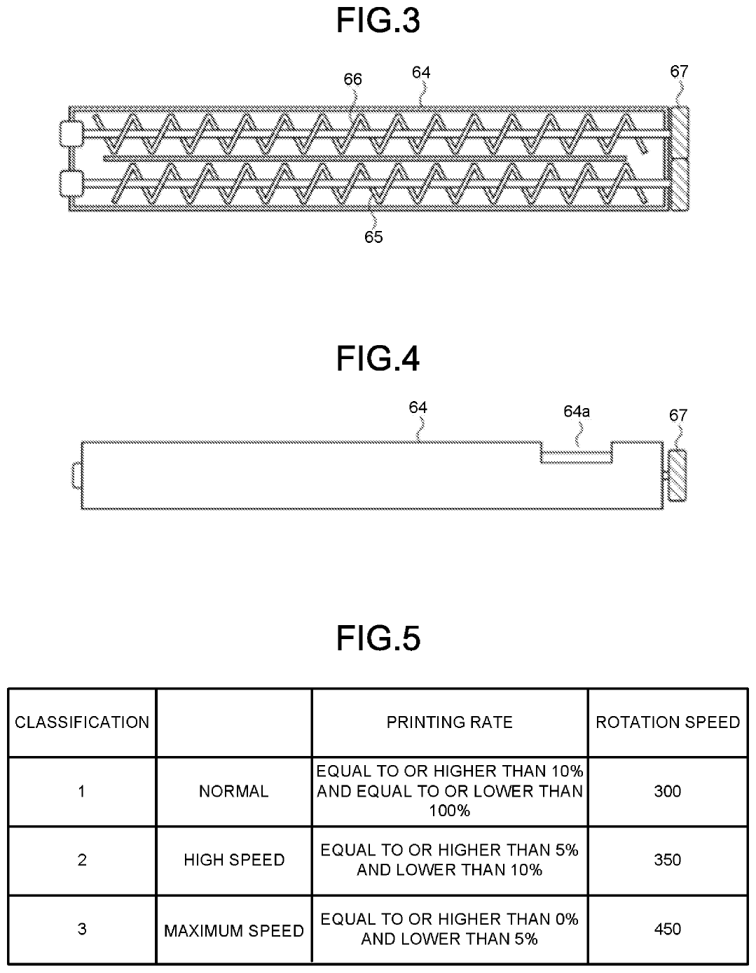

As shown in FIGS. 3 and 4, a discharge port 64a for discharging the excess developer is formed on the top of the developer container 64. The stirring members 65 and 66 are arranged in mutually different directions in the developer container 64 so as to convey the developer. The stirring members 65 and 66 are driven by the motor 68 via the gear 67. The motor 68 is controlled by the processor 21 to be driven. Therefore, the rotation speeds of the stirring members 65 and 66 are controlled by the processor 21.

The toner replenishment motor 55 rotates a screw of the toner cartridge 2 to supply the toner from the toner cartridge 2 to the developing device 53. The toner replenishment motor 55 rotates a drive mechanism (not shown). The drive mechanism is connected to the screw (described below) of the toner cartridge 2 when the toner cartridge 2 is installed in the image forming apparatus 1. The screw rotates as the drive mechanism rotates.

The toner sensor 69 is a magnetic sensor that detects the toner density in the developer in the housing 61 of the developing device 53. The toner sensor 69 transmits a toner sensor detection voltage to the system controller 13. The system controller 13 determines the density of the toner remaining in the housing 61, and performs a processing of determining whether or not the toner replenishment is required. The toner is replenished from the toner cartridge 2 to the housing 61 based on the toner sensor detection voltage.

The exposure device 54 includes a plurality of light emitting elements (light emitters). The exposure device 54 forms a latent image on the photoconductive drum 51 by irradiating the photoconductive drum 51 with light from the light emitting element. The light emitting element is, for example, an LED (Light Emitting Diode) or the like. One light emitting element may emit light to one point on the photoconductive drum 51. The plurality of light emitting elements is aligned in a main scanning direction parallel to a rotation axis of the photoconductive drum 51.

The exposure device 54 forms a latent image for one line on the photoconductive drum 51 by irradiating the photoconductive drum 51 with the light from the plurality of light emitting elements aligned in the main scanning direction. Furthermore, the exposure device 54 forms the latent images by continuously irradiating the rotating photoconductive drum 51 with the light.

The toner replenishment motor 55 rotates the screw of the toner cartridge 2 to supply the toner from the toner cartridge 2 to the developing device 53. The toner replenishment motor 55 rotates a drive mechanism (not shown). The drive mechanism is connected to the screw (described below) of the toner cartridge 2 when the toner cartridge 2 is installed in the image forming apparatus 1. The screw rotates as the drive mechanism rotates.

The communication interface 56 establishes communication with the toner cartridge 2.

In the configuration described above, if the surface of the photoconductive drum 51 charged by the electrostatic charger 52 is irradiated with the light from the exposure device 54, an electrostatic latent image is formed thereon. When the developer layer formed on the surface of the developing roller 62 approaches the photoconductive drum 51, the toner contained in the developer adheres to the latent image formed on the surface of the photoconductive drum. In this way, the processing unit 41 forms the toner image on the surface of the photoconductive drum 51.

The processor 21 of the system controller 13 calculates the printing rate G based on the image data. The printing rate G is a ratio of an area in which the printing is performed to a printing area of the printing medium P which is set as 100%. For example, an average value of the printing rate G is calculated every 1000 sheets of the printing media P, and is then stored in the memory 22. The processor 21 determines the rotation speeds of the stirring members 65 and 66 based on the printing rate G stored in the memory 22 and a rotation speed adjustment table. The processor 21 controls the motor 68 to change the rotation speeds of the stirring members 65 and 66.

The transfer mechanism 42 transfers the toner image formed on the surface of the photoconductive drum 51 onto the print medium P. The transfer mechanism 42 includes, for example, a primary transfer belt 71, a secondary transfer opposing roller 72, a plurality of primary transfer rollers 73 and a secondary transfer roller 74.

The primary transfer belt 71 is an endless belt wound around the secondary transfer opposing roller 72 and a plurality of winding rollers. An inner surface (inner circumferential surface) of the primary transfer belt 71 contacts the secondary transfer opposing roller 72 and a plurality of winding rollers, and an outer surface (outer circumferential surface) thereof faces the photoconductive drum 51 of the processing unit 41.

The secondary transfer opposing roller 72 is rotated by a motor (not shown). The secondary transfer opposing roller 72 rotates to convey the primary transfer belt 71 in a predetermined conveyance direction. The plurality of winding rollers is freely rotatable. The plurality of winding rollers rotates as the primary transfer belt 71 is moved by the secondary transfer opposing roller 72.

The plurality of primary transfer rollers 73 enables the primary transfer belt 71 to contact the photoconductive drum 51 of the processing unit 41. The plurality of primary transfer rollers 73 is provided to correspond to the photoconductive drums 51 of the plurality of processing units 41, respectively. Specifically, the plurality of primary transfer rollers 73 is arranged at positions facing the photoconductive drums 51 of the corresponding processing units 41 across the primary transfer belt 71. The primary transfer roller 73 contacts the inner circumferential surface side of the primary transfer belt 71 to displace the primary transfer belt 71 towards the photoconductive drum 51 side. In this way, the primary transfer roller 73 enables the outer circumferential surface of the primary transfer belt 71 to contact the photoconductive drum 51.

The secondary transfer roller 74 is arranged at a position facing the secondary transfer opposing roller 72 across the primary transfer belt 71. The secondary transfer roller 74 contacts the outer circumferential surface of the primary transfer belt 71 to apply pressure thereto. In this way, a transfer nip is formed at which the secondary transfer roller 74 closely contacts the outer circumferential surface of the primary transfer belt 71. When the print medium P passes through the transfer nip, the secondary transfer roller 74 presses the print medium P passing through the transfer nip against the outer circumferential surface of the primary transfer belt 71.

The secondary transfer roller 74 and the secondary transfer opposing roller 72 rotate to convey the print medium P fed from the sheet feed conveyance path 31 in a state of sandwiching the print medium P therebetween. In this way, the print medium P passes through the transfer nip.

The toner image formed on the surface of the photoconductive drum is transferred onto the outer circumferential surface of the primary transfer belt 71. In a case in which the image forming section 19 includes a plurality of processing units 41, the primary transfer belt 71 receives toner images from the photoconductive drums 51 of the plurality of processing units 41. The toner image transferred onto the outer circumferential surface of the primary transfer belt 71 is conveyed by the primary transfer belt 71 to the transfer nip at which the secondary transfer roller 74 closely contacts the outer circumferential surface of the primary transfer belt 71. When the print medium P is present in the transfer nip, the toner image transferred onto the outer circumferential surface of the primary transfer belt 71 is transferred onto the print medium P at the transfer nip.

The processor 21 forms toner pattern images having different densities for respective toners on the primary transfer belt 71 through the respective processing units 41, and determines the densities of the toner pattern images to adjust image forming conditions.

The density sensor 43 detects the density of the toner pattern image transferred onto the outer circumferential surface of the primary transfer belt 71, and the processor may use the detected density information from the density sensor.

Next, a configuration relating to the fixing in the image forming apparatus 1 is described.

The fixing device 20 fixes the toner image to the print medium P onto which the toner image is transferred. The fixing device 20 operates under the control of the system controller 13. The fixing device 20 includes a heating member that applies heat to the print medium P and a pressure member that applies pressure to the print medium P. For example, the heating member is, for example, a heating roller 81. For example, the pressure member is a pressure roller 82.

The heating roller 81 is a fixing rotation member rotated by a motor (not shown). The heating roller 81 has a hollow core made of metal and an elastic layer formed on an outer circumference of the core. The heating roller 81 is heated to a high temperature by a heater arranged in the hollow core. The heater is, for example, a halogen heater. The heater may be an IH (Induction Heating) heater for heating the core through electromagnetic induction.

The pressure roller 82 is arranged at a position facing the heating roller 81. The pressure roller 82 has a core made of metal and having a predetermined external diameter, and an elastic layer formed on the outer circumference of the core. The pressure roller 82 applies pressure to the heating roller 81 through stress applied from a tension member (not shown). By applying the pressure to the heating roller 81 from the pressure roller 82, a so-called fixing nip at which the pressure roller 82 closely contacts the heating roller 81 is formed. The pressure roller 82 is rotated by a motor (not shown). The pressure roller 82 rotates to move the print medium P entering the fixing nip while pressing the print medium P against the heating roller 81.

According to the above configuration, the heating roller 81 and the pressure roller 82 apply heat and pressure to the print medium P passing through the fixing nip. As a result, the toner image is fixed to the print medium P passing through the fixing nip. The print medium P passing through the fixing nip is guided to the sheet discharge conveyance path 32 and then discharged to the outside of the housing 11.

Next, a configuration of the toner cartridge 2 is described. As shown in FIG. 2, the toner cartridge 2 includes a storing container 91, a screw 92 and an IC (integrated circuit) chip 94. The storing container 91 is connected to the housing 61 of the developing device 53 when the toner cartridge 2 is installed in the image forming apparatus 1.

The screw 92 is provided in the storing container 91 and rotates to transmit the toner in the storing container 91 to the developing device 53. The screw 92 is driven by the toner replenishment motor 55 of the processing unit 41.

Next, the control performed by the processor 21 of the system. controller 13 is described. The processor 21 calculates the printing rate G every time 1000 sheets are printed, and stores the calculated printing rate G in the memory 22. An initial value of the printing rate G stored in the memory 22 is set to 15%. The initial value 15% is appropriately selected from 10% to 100% set as a range of a standard printing rate. The processor 21 reads out the printing rate G stored in the memory 22 at the start of printing. Next, the processor 21 determines the control for the motor 68 based on the rotation speed adjustment table shown in FIG. 5. In the rotation speed adjustment table, the rotation speed is set in three stages of “normal,” “highspeed” and “maximum speed.” The “normal” refers to a case in which the printing rate is equal to or higher than 10% and equal to or lower than 100% and the rotation speed is 300 rpm, the “high speed” refers to a case in which the printing rate is equal to or higher than 5% and lower than 10% and the rotation speed is 350 rpm, and the “maximum speed” refers to a case in which the printing rate is equal to or higher than 0% and lower than 5% and the rotation speed is 450 rpm.

Since the normal printing rate 15% is stored in the memory 22 as the initial value at the start of the printing, the stirring members 65 and 66 are driven to rotate at the normal speed. The processor 21 reads out an average printing rate G for the latest printed 1000 sheets, which is stored in the memory 22, at a predetermined rotation speed change timing. Even if the criterion is 1000 sheets, the rotation speed change timing may be changed before reaching 1000 sheets based on the toner density after printing or an amount of toner in the housing 61. Furthermore, the rotation speed change timing may be changed based on a certain elapsed time, such as a predetermined elapsed time.

The processor 21 rotates the stirring members 65 and 66 at a rotation speed of 300 rpm at which the rotation speed is the “normal”, and at the printing rate G set to 15% at the start of the printing. While the printing on 1000 sheets is performed from the start of printing, the average printing rate G for 1000 sheets is calculated and stored in the memory 22.

At a time point at which the printing on the first 1000 sheets is completed, if the printing rate G stored in the memory 22 is 8%, the stirring members 65 and 66 are rotated at the rotation speed of 350 rpm at which the rotation speed is the “high speed” (e.g., a speed above a predetermined speed), based on the rotation speed adjustment table. While the printing on the next 1000 sheets is performed, an average printing rate G for 1000 sheets is calculated and stored in the memory 22.

At the time point at which the printing on the 1000 sheets is completed, if the printing rate G stored in the memory 22 is 3%, the stirring members 65 and 66 are rotated at a rotation speed of 450 rpm at which the rotation speed is the “maximum speed”, based on the rotation speed adjustment table. Thereafter, the rotation speed is set to one of the rotation speeds in three stages of the “normal”, “high speed” and “maximum speed” based on the rotation speed adjustment table according to the change in the printing rate G, and the stirring members 65 and 66 are rotated at the set rotation speed.

As described above, if the printing rate G is low (e.g., lower than a predetermined printing rate), by rotating the stirring members 65 and 66 at the high speed, a feed amount of developer in the developer container 64 is increased. As the feed amount of developer increases, the amount of developer accumulated at the discharge port 64a increases. The toner having a small particle size in the developer has a high charge amount, and many external additives adhere thereto. Since the toner is lighter (less heavy) than the carrier, the toner is more easily accumulated over the developer container 64, and the toner is more easily discharged from the discharge port 64a.

In this way, if the printing rate G is low, the discharge speed of the developer in the developer container 64 is accelerated to prevent deteriorated developer from being retained in the developer container 64 for a long time. Therefore, according to the image forming apparatus 1, the deterioration in the developer can be prevented even in the case of using toner having a small particle size.

The functions described in the above-described embodiments can be performed not only by using hardware but also by enabling a computer to read programs in which the functions are implemented through software (including as executable instructions stored in a non-transitory memory). The functions may be performed by software and/or hardware selected as appropriate. Although the printing rate for determining the rotation speed of the stirring member may be changed every 1000 sheets, for example, the number of printed sheets is not limited thereto. The relationship between the printing rate and the rotation speed of the stirring member is not limited to the above-described rotation speed adjustment table, as long as the rotation speed of the stirring member is increased as the printing rate becomes low, and the type of speed is not limited to three types. Moreover, the printing rate may be calculated based on the image data, or may be directly read by a sensor from a printed matter actually printed or the like.

While certain embodiments have been described, these embodiments have been presented by way of example only, and are not intended to limit the scope of invention. Indeed, the novel apparatus and methods described herein may be embodied in a variety of other forms. Furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

1. An image forming apparatus, comprising:
an electrostatic latent image carrier;
a charger configured to charge a surface of the electrostatic latent image carrier;
an exposure device configured to expose the surface of the electrostatic latent image carrier, which is charged by the charger based on image data, to form an electrostatic latent image;
a developing container configured to store developer composed of a toner and a carrier;
one or more stirring members configured to stir the developer in the developing container;
a developer carrier configured to rotate in the developing container and accumulate the stirred developer on a surface of the developer carrier, and supply the stirred developer from the surface of the developer carrier to the electrostatic latent image carrier; and
a controller configured to calculate a printing rate based on the image data and increase a rotation speed of the one or more stirring members in response to a determination that the printing rate is equal to or lower than a predetermined printing rate.

2. The image forming apparatus according to claim 1, wherein
the toner comprises a plurality of particles each having a size of about 4 μm to about 6 μm.

3. The image forming apparatus according to claim 1, wherein
the one or more stirring members are each configured to convey the developer in the developing container.

4. The image forming apparatus according to claim 3, wherein
the one or more stirring members are arranged in the developing container so as to convey the developer in mutually opposite directions.

5. The image forming apparatus according to claim 1, wherein
the developing container includes a discharge port for discharging the developer from the developing container.

6. The image forming apparatus according to claim 5, wherein when the printing rate is lower than the predetermined printing rate, the controller is configured to control the rotation speed to be above a predetermined speed so as to increase a feed amount of the developer and to cause the developer to accumulate at the discharge port.

7. An image forming method, comprising:
stirring a developer composed of a toner and a carrier at a predetermined stirring speed with one or more stirring members in a developing container;
calculating a printing rate based on input image data;
charging a surface of an electrostatic latent image carrier with a charger;
forming an electrostatic latent image by exposing the surface of the electrostatic latent image based on the image data;
accumulating the stirred developer on a surface of a developer carrier arranged to rotate in the developing container, and supplying, by the developer carrier, the stirred developer from the surface of the developer carrier to the electrostatic latent image carrier;
increasing a rotation speed of the one or more stirring members upon determining that the printing rate is equal to or lower than a predetermined printing rate; and
discharging excess developer from the developing container.

8. The image forming method according to claim 7, wherein
the toner comprises a plurality of particles having a size of about 4 μm to about 6 μm.

9. The image forming method according to claim 7, further comprising:
arranging the one or more stirring members in the developing container so as to convey the developer in mutually opposite directions.

10. The image forming method according to claim 7, further comprising:
discharging the developer from the developing container via a discharge port.

11. The image forming method according to claim 10, further comprising:
when the printing rate is lower than the predetermined printing rate, controlling the rotation speed to be above a predetermined speed so as to increase a feed amount of the developer and to cause the developer to accumulate at the discharge port.

12. A non-transitory computer readable medium configured to store instructions which, when executed by a processor of an image forming apparatus, cause the image forming apparatus to perform operations comprising:
stirring developer composed of a toner and a carrier at a predetermined stirring speed with one or more stirring members in a developing container;
determining a printing rate based on input image data;
charging a surface of an electrostatic latent image carrier with a charging device;
forming an electrostatic latent image by exposing the surface of the electrostatic latent image based on the image data;
accumulating the stirred developer on a surface of a developer carrier arranged to rotate in the developing container, and supplying, by the developer carrier, the stirred developer from the surface of the developer carrier to the electrostatic latent image carrier;
increasing a rotation speed of the one or more stirring members upon determining that the printing rate is equal to or lower than a predetermined printing rate; and
discharging excess developer from the developing container.

13. The non-transitory computer readable medium of claim 12, wherein
the toner comprises particles having a size of about 4 μm to about 6 μm.

14. The non-transitory computer readable medium of claim 12, wherein the image forming apparatus is arranged such that the one or more stirring members are disposed in the developing container so as to convey the developer in mutually opposite directions.

15. The non-transitory computer readable medium of claim 12, wherein discharging the developer comprises causing the developer to be discharged via a discharge port of the developing container.

16. The non-transitory computer readable medium of claim 15, wherein the operations further comprise:
when the printing rate is lower than the predetermined printing rate, controlling the rotation speed to be above a predetermined speed so as to increase a feed amount of the developer and to cause the developer to accumulate at the discharge port.

17. The image forming apparatus according to claim 1, wherein
the controller is configured to determine the rotation speed of the one or more stirring members based on the printing rate and a rotation speed adjustment table.

18. The image forming apparatus according to claim 17, wherein
the controller is configured to read out the printing rate at a predetermined rotation speed change timing of the one or more stirring members, and adjust the rotation speed change timing according to one of an elapsed time, a toner density, or an amount of toner.
